(19) United States
(12) Patent Application Publication
(10) Pub. No.: US 2026/0341880 A1
(43) Pub. Date: Oct. 29, 2026

(54) BATTERY PACK ENCLOSURE RETENTION ASSEMBLY

(71) Applicant: Ford Global Technologies, LLC, Dearborn, MI (US)

(72) Inventors: Rajaram Subramanian, Ann Arbor, MI (US); Hari Krishna Addanki, Novi, MI (US); Steve Droste, Canton, MI (US); Kevin A. Montgomery, Royal Oak, MI (US); Suriyaprakash Ayyangar Janarthanam, Canton, MI (US)

(21) Appl. No.: 19/190,972

(22) Filed: Apr. 28, 2025

(51) Int. Cl. H01M 50/262; H01M 50/211; H01M 50/249; H01M 50/276

(52) U.S. Cl. CPC H01M 50/262; H01M 50/249; H01M 50/276; H01M 50/211; H01M 2220/20

(57) ABSTRACT

A traction battery pack assembly includes a first enclosure section; a second enclosure section, and at least one retention tab of the first enclosure section. The at least one retention tab is wrapped around a portion of the second enclosure section to secure the first enclosure section relative to the second enclosure section.

### TECHNICAL FIELD

This disclosure relates generally to joining enclosure pieces of a battery pack and, more particularly, to joining using retention assemblies that do not include mechanical fasteners.

### BACKGROUND

Electrified vehicles differ from conventional motor vehicles because electrified vehicles can be selectively driven by one or more electric machines that are powered by a traction battery pack. The electric machines can propel the electrified vehicles instead of, or in combination with, an internal combustion engine. The traction battery pack can include at least one battery cell held within an enclosure.

### SUMMARY

In some aspects, the techniques described herein relate to a traction battery pack assembly, including: a first enclosure section; a second enclosure section; and at least one retention tab of the first enclosure section, the at least one retention tab wrapped around a portion of the second enclosure section to secure the first enclosure section relative to the second enclosure section.

In some aspects, the techniques described herein relate to a traction battery pack assembly, wherein the first enclosure section is an enclosure cover, and the second enclosure section is an enclosure tray.

In some aspects, the techniques described herein relate to a traction battery pack assembly, wherein the first enclosure section includes a first outer rim, the at least one retention tab provided within the first outer rim.

In some aspects, the techniques described herein relate to a traction battery pack assembly, wherein first outer rim extends circumferentially about a perimeter of the first enclosure section.

In some aspects, the techniques described herein relate to a traction battery pack assembly, wherein the second enclosure section includes a second outer rim having an aperture, the at least one retention tab extending through the aperture and wrapped around the second outer rim.

In some aspects, the techniques described herein relate to a traction battery pack assembly, wherein the at least one retention tab includes a first retention tab and a second tab extending through the aperture, the first retention tab wrapped around the second outer rim on a first side of the aperture, the second tab wrapped around the second outer rim on an opposite, second side of the aperture.

In some aspects, the techniques described herein relate to a traction battery pack assembly, wherein the first enclosure section and the second enclosure section are configured to house at least one battery cell within an interior area when secured to each other, the first retention tab inboard the second tab relative to the interior area.

In some aspects, the techniques described herein relate to a traction battery pack assembly, wherein the first retention tab and the second tab each include a rib.

In some aspects, the techniques described herein relate to a traction battery pack assembly, wherein the first enclosure section includes a first outer rim and the second enclosure section includes a second outer rim, the at least one retention tab including a plurality of pairs of retention tabs established within the first outer rim and circumferentially distributed about the first enclosure section, each pair of retention tabs extending through one of a plurality of apertures provided within the second outer rim and wrapped around the second outer rim.

In some aspects, the techniques described herein relate to a traction battery pack assembly, wherein the first enclosure section and the second enclosure section are secured relative to each other to provide an interior area that houses at least one battery cell of a traction battery pack, the first outer rim and the second outer rim each extending circumferentially continuously about the interior area.

In some aspects, the techniques described herein relate to a traction battery pack assembly, further including a seal sandwiched between the first outer rim and the second outer rim, the seal inboard the plurality of pairs of retention tabs relative to the interior area.

In some aspects, the techniques described herein relate to a traction battery pack assembly, wherein the plurality of pairs of retention tabs wrap around the second outer rim such that the plurality of pairs of retention tabs sandwich a portion of the second outer rim against the first outer rim.

In some aspects, the techniques described herein relate to a traction battery pack assembly, wherein, for each of the plurality of pairs of retention tabs, one of the retention tabs is wrapped toward the interior area and one of the retention tabs is wrapped away from the interior area.

In some aspects, the techniques described herein relate to a traction battery pack assembly, wherein the first enclosure section is a metal or metal alloy.

In some aspects, the techniques described herein relate to a traction battery pack assembly, including: a plurality of retention tabs in a first enclosure section, the plurality of retention tabs each wrapped around a portion of a second enclosure section to secure the first enclosure section relative to the second enclosure section; and a plurality of battery cells housed within an interior area that is at least partially provided by the first enclosure section and the second enclosure section.

In some aspects, the techniques described herein relate to a traction battery assembly, further including the first enclosure section and the second enclosure section, the plurality of retention tabs provided within an outer rim of the first enclosure section, the plurality of retention tabs each extending through an aperture in an outer rim of the second enclosure section.

In some aspects, the techniques described herein relate to a traction battery assembly, wherein the first and second enclosure sections are secured to each other without mechanical fasteners.

In some aspects, the techniques described herein relate to a traction battery assembly, wherein the plurality of retention tabs are folded over the portion.

In some aspects, the techniques described herein relate to a traction battery assembly, wherein the plurality of retention tabs include a plurality of pairs of retention tabs, each of the pairs of retention tabs extending through a single opening in the second enclosure section.

In some aspects, the techniques described herein relate to a traction battery assembly, wherein the pairs of retention tabs each include an inboard retention tab and an outboard retention tab.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates a perspective view of a battery pack from the electrified vehicle of FIG. 1 with a battery array shown schematically.

FIG. 3 illustrates a close-up view of an area of FIG. 2.

FIG. 4. illustrates an expanded view of the battery pack of FIG. 3.

FIG. 5 illustrates a close-up view of an area of FIG. 4.

FIG. 6 illustrates a close-up view of an area of FIG. 5.

FIG. 7 illustrates a section view taken at line 7-7 in FIG. 3.

FIG. 8 illustrates the section view of FIG. 7 after moving a first enclosure section adjacent to a second enclosure section.

FIG. 9 illustrates the section view of FIG. 8 after moving a pair of retention tabs of the first enclosure section through an aperture in the second enclosure section.

FIG. 10 illustrates the section view of FIG. 9 after wrapping the pair of retention tabs of the first enclosure section around respective portions of the second enclosure section.

### DETAILED DESCRIPTION

This disclosure details exemplary retention assemblies that can be used to secure together sections of a traction battery pack enclosure assembly. The retention assemblies can include at least one retention tab that wraps around a portion of one of the enclosure sections. The retention tab can be used to secure together the enclosure sections instead of, or in addition to, a mechanical fastener, such as a bolt.

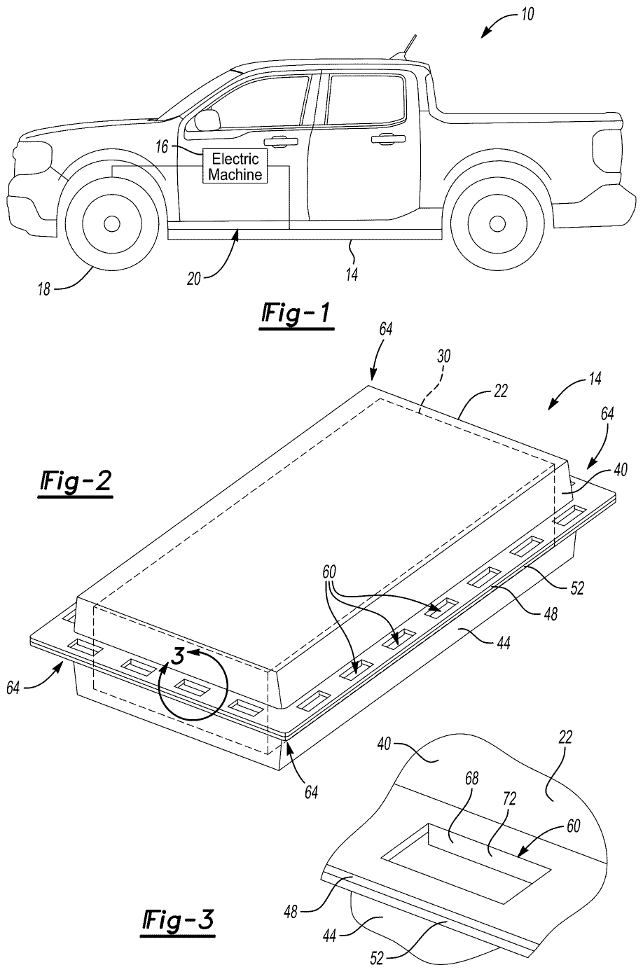

With reference to FIG. 1, an electrified vehicle 10 includes a battery pack 14, an electric machine 16, and wheels 18. The battery pack 14 powers the electric machine 16, which can convert electrical power to mechanical power to drive the wheels 18. The battery pack 14 is thus a traction battery pack.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

The battery pack 14 is, in the exemplary embodiment, is secured to an underbody 20 of the electrified vehicle 10. The battery pack 14 could be located elsewhere on the electrified vehicle 10 in other examples.

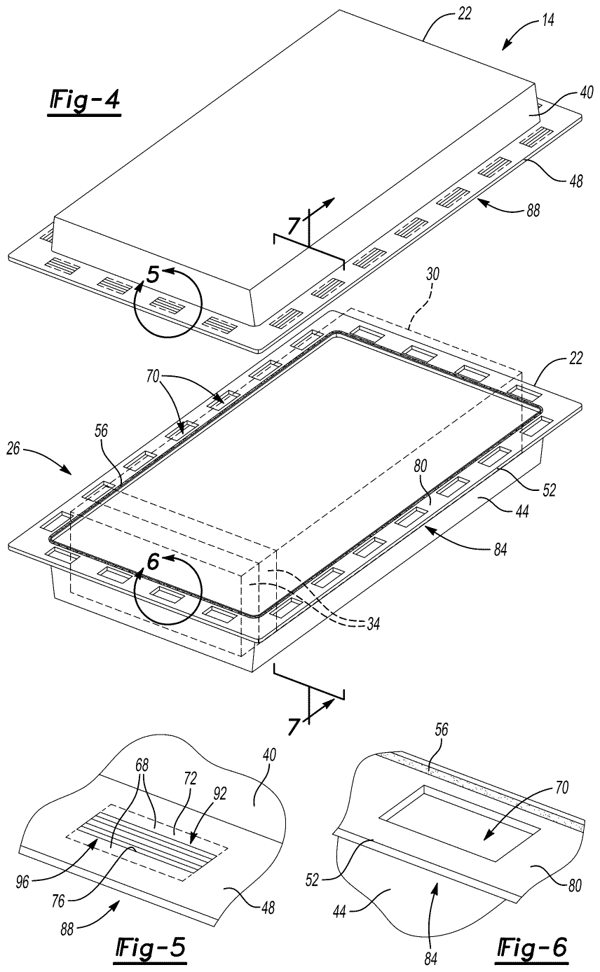

With reference now to FIGS. 2-6, in the exemplary embodiment, the traction battery pack 14 includes an enclosure assembly 22 that provides an interior area 26. The traction battery pack 14 includes one or more battery arrays 30 held within the interior area 26. The one or more battery arrays 30 can each include a plurality of individual battery cells.

The battery cells 34 store and supply electrical power. The battery pack 14 could include any number of the battery arrays 30 each having any number of individual battery cells 34. In an embodiment, the battery cells 34 are lithium-ion pouch-style cells. However, battery cells having other geometries (cylindrical, prismatic, etc.), other chemistries (nickel metal hydride, lead acid, etc.), or both could be alternatively utilized.

In this example, the enclosure assembly 22 includes a first enclosure section 40 and a second enclosure section 44 that are secured relative to each other to provide the interior area 26. In other examples, more than two enclosure sections are secured relative to each other to provide the interior area 26.

The first enclosure section 40 of the example enclosure assembly 22 is an enclosure cover or lid. The second enclosure section 44 of the example enclosure assembly 22 is an enclosure tray.

The first enclosure section 40 and the second enclosure section 44 are both metal or metal alloy in this example. The first enclosure section 40 and the second enclosure section 44 could both be aluminum. In another example, the first enclosure section 40 could be metal and the second enclosure section 44 could be another material, such as a polymer-based material.

The first enclosure section 40 includes a first outer rim 48 that projects outward away from the interior area 26. The second enclosure section 44 includes a second outer rim 52 that projects outward away from the interior area 26. The first outer rim 48 and the second outer rim 52 each extend circumferentially continuously about an entire perimeter of the interior area 26.

The first outer rim 48 and the second outer rim 52 are connected to each other to secure the first enclosure section 40 relative to the second enclosure section 44. The battery pack 14 includes a perimeter seal 56 sandwiched between the first outer rim 48 and the second outer rim 52. The perimeter seal 56 extends circumferentially continuously about the entire perimeter of the interior area 26.

The example enclosure assembly 22 includes a plurality of retention assemblies 60 that are used to connect the first outer rim 48 to the second outer rim 52, which connects the first enclosure section 40 to the second enclosure section 44. The plurality of retention assemblies 60 are distributed circumferentially about the interior area 26. The plurality of retention assemblies 60 can be positioned closer to each other near corners 64 of the enclosure assembly 22.

The perimeter seal 56 is inboard the plurality of retention assemblies 60. That is, the perimeter seal 56 is between the plurality of retention assemblies 60 and the interior area 26.

In this example, the plurality of retention assemblies 60 each include a pair of retention tabs 68 provided within the first outer rim 48. The pairs of retention tabs 68 each extend through an aperture 70 in the second outer rim 52 and wrap around a portion of the second outer rim 52 to secure the first enclosure section 40 relative to the second enclosure section 44.

The pairs of retention tabs 68 each include a first retention tab 72 and a second retention tab 76. In this example, the first retention tab 72 is wrapped around the second outer rim 52 on a first side of the respective aperture 70. The second retention tab 76 is wrapped around the second outer rim 52 on an opposite, second side of the aperture 70.

Relative to the interior area 26, the first side of the aperture 70 is an inboard side of the aperture 70 and the second side is an outboard side of the aperture. The first retention tab 72 is wrapped toward the interior area 26, and the second retention tab 76 is wrapped away from the interior area 26.

After wrapping the pairs of retention tabs 68, the retention tabs 68 extend from a top side 80 of the second outer rim 52, through the aperture 70, to a position where the retention tabs 68 contact an underside 84 of the second outer rim 52. The retention tabs 68 thus each capture a portion of the second outer rim 52 and sandwich the portion against an underside 88 of the first outer rim 48.

The first retention tab 72 includes a first retention tab rib 92, which can help to ensure good contact between the first retention tab 72 and the underside 84 of the second outer rim 52. Similarly, the second retention tab 76 includes a second retention tab rib 96, which can help to ensure good contact between the second retention tab 76 and the underside 84 of the second outer rim 52.

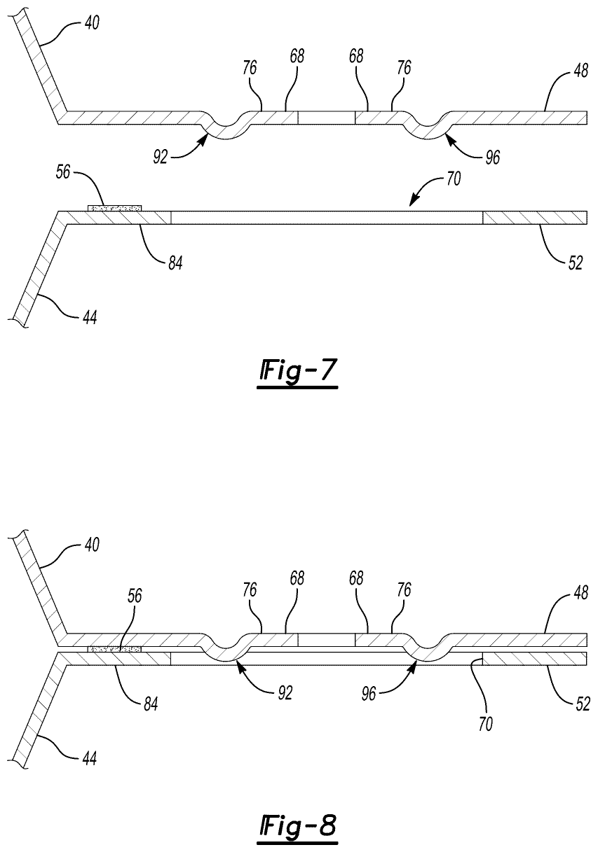

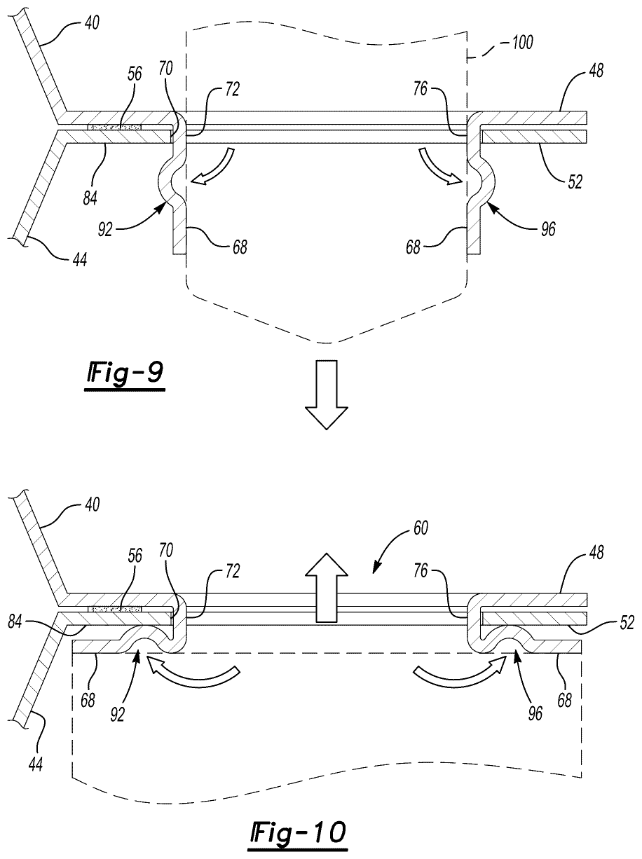

With reference now to FIGS. 7-10 and continuing reference to claims 2-6, securing the first enclosure section 40 to the second enclosure section 44 can involve first moving the first enclosure section 40 and the second enclosure section 44 from the position of FIG. 7 to the position of FIG. 8 where the perimeter seal 56 is sandwiched and the pair of retention tabs 68 extend over the aperture 70. Next, as shown in FIG. 9, assembly tooling 100, such as press or stamping tooling, is used to bend the pair of retention tabs 68 into the aperture 70. The assembly tooling 100 is then withdrawn from the aperture 70.

As shown in FIG. 10, additional assembly tooling 104 is then used to bend or fold the pair of retention tabs 68 further such that the pair of retention tabs 68 wrap around portions of the second outer rim 52 and contact the underside 84 of the second outer rim 52. After the bending shown in FIG. 10, the pair of retention tabs 68 are folded over the portions of the second outer rim 52.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack assembly, comprising:
a first enclosure section;
a second enclosure section; and
at least one retention tab of the first enclosure section, the at least one retention tab wrapped around a portion of the second enclosure section to secure the first enclosure section relative to the second enclosure section.

2. The traction battery pack assembly of claim 1, wherein the first enclosure section is an enclosure cover, and the second enclosure section is an enclosure tray.

3. The traction battery pack assembly of claim 1, wherein the first enclosure section includes a first outer rim, the at least one retention tab provided within the first outer rim.

4. The traction battery pack assembly of claim 3, wherein first outer rim extends circumferentially about a perimeter of the first enclosure section.

5. The traction battery pack assembly of claim 3, wherein the second enclosure section includes a second outer rim having an aperture, the at least one retention tab extending through the aperture and wrapped around the second outer rim.

6. The traction battery pack assembly of claim 5, wherein the at least one retention tab includes a first retention tab and a second tab extending through the aperture, the first retention tab wrapped around the second outer rim on a first side of the aperture, the second tab wrapped around the second outer rim on an opposite, second side of the aperture.

7. The traction battery pack assembly of claim 6, wherein the first enclosure section and the second enclosure section are configured to house at least one battery cell within an interior area when secured to each other, the first retention tab inboard the second tab relative to the interior area.

8. The traction battery pack assembly of claim 6, wherein the first retention tab and the second tab each include a rib.

9. The traction battery pack assembly of claim 1, wherein the first enclosure section includes a first outer rim and the second enclosure section includes a second outer rim, the at least one retention tab including a plurality of pairs of retention tabs established within the first outer rim and circumferentially distributed about the first enclosure section, each pair of retention tabs extending through one of a plurality of apertures provided within the second outer rim and wrapped around the second outer rim.

10. The traction battery pack assembly of claim 9, wherein the first enclosure section and the second enclosure section are secured relative to each other to provide an interior area that houses at least one battery cell of a traction battery pack, the first outer rim and the second outer rim each extending circumferentially continuously about the interior area.

11. The traction battery pack assembly of claim 10, further comprising a seal sandwiched between the first outer rim and the second outer rim, the seal inboard the plurality of pairs of retention tabs relative to the interior area.

12. The traction battery pack assembly of claim 10, wherein the plurality of pairs of retention tabs wrap around the second outer rim such that the plurality of pairs of retention tabs sandwich a portion of the second outer rim against the first outer rim.

13. The traction battery pack assembly of claim 10, wherein, for each of the plurality of pairs of retention tabs, one of the retention tabs is wrapped toward the interior area and one of the retention tabs is wrapped away from the interior area.

14. The traction battery pack assembly of claim 10, wherein the first enclosure section is a metal or metal alloy.

15. A traction battery pack assembly, comprising:
a plurality of retention tabs in a first enclosure section, the plurality of retention tabs each wrapped around a portion of a second enclosure section to secure the first enclosure section relative to the second enclosure section; and
a plurality of battery cells housed within an interior area that is at least partially provided by the first enclosure section and the second enclosure section.

16. The traction battery assembly of claim 15, further comprising the first enclosure section and the second enclosure section, the plurality of retention tabs provided within an outer rim of the first enclosure section, the plurality of retention tabs each extending through an aperture in an outer rim of the second enclosure section.

17. The traction battery assembly of claim 15, wherein the first and second enclosure sections are secured to each other without mechanical fasteners.

18. The traction battery assembly of claim 15, wherein the plurality of retention tabs are folded over the portion.

19. The traction battery assembly of claim 15, wherein the plurality of retention tabs include a plurality of pairs of retention tabs, each of the pairs of retention tabs extending through a single opening in the second enclosure section.

20. The traction battery assembly of claim 19, wherein the pairs of retention tabs each include an inboard retention tab and an outboard retention tab.
